(19) United States
(12) Patent Application Publication
(10) Pub. No.: US 2023/0074531 A1
(43) Pub. Date: Mar. 9, 2023

(54) INFORMATION PROCESSING APPARATUS, INFORMATION PROCESSING METHOD, AND NON-TRANSITORY STORAGE MEDIUM

(71) Applicant: Toyota Jidosha Kabushiki Kaisha, Toyota-shi (JP)

(72) Inventors: Tomo Sasaki, Toyota -shi (JP); Kenichi Yamada, Nisshin-shi (JP); Koki Maeda, Miyoshi-shi (JP); Tsuyoshi Okada, Nagoya-shi (JP)

(73) Assignee: Toyota Jidosha Kabushiki Kaisha, Toyota-shi (JP)

(21) Appl. No.: 17/903,082

(22) Filed: Sep. 6, 2022

(30) Foreign Application Priority Data
Sep. 8, 2021 (JP) 2021-146110

(51) Int. Cl. G06Q 10/08

(52) U.S. Cl. CPC G06Q 10/08355

(57) ABSTRACT

In an information processing apparatus, a controller derives, on the basis of a scheduled traveling route of a vehicle provided with a safekeeping apparatus storing baggage of a user and position information of the user, a rejoining point and a rejoining timing at which the vehicle and the user are capable of rejoining together. The controller also proposes the rejoining point and the rejoining timing to the user.

### CROSS REFERENCE TO THE RELATED APPLICATION

This application claims the benefit of Japanese Patent Application No. 2021-146110, filed on Sep. 8, 2021, which is hereby incorporated by reference herein in its entirety.

### BACKGROUND

### Technical Field

The present disclosure relates to a technique for a user to use a safekeeping apparatus provided on a vehicle.

### Description of the Related Art

Patent Literature 1 in the citation list below discloses a management system for managing a self-driving vehicle including a locker. In the management system disclosed in Patent Literature 1, a server manages availability of a self-driving locker (a locker provided on a self-driving vehicle) and a fixed locker. If a request is made to use a locker from a user, the server makes a reservation for the self-driving locker or the fixed locker on the basis of the availability.

### CITATION LIST

### Patent Literature

Patent Literature 1: Japanese Patent Laid-Open No. 2019-096201

### SUMMARY

An object of the present disclosure is to provide a technique capable of improving convenience when a user leaves baggage in a safekeeping apparatus provided on a vehicle.

An information processing apparatus according to the present disclosure may include

a controller configured to execute

deriving, on the basis of a scheduled traveling route of a vehicle provided with a safekeeping apparatus storing baggage of a user and position information of the user, a rejoining point and a rejoining timing at which the vehicle and the user are capable of rejoining together, and

proposing the rejoining point and the rejoining timing to the user.

An information processing method according to the present disclosure may include

deriving, on the basis of a scheduled traveling route of a vehicle provided with a safekeeping apparatus storing baggage of a user and position information of the user, a rejoining point and a rejoining timing at which the vehicle and the user are capable of rejoining together, and

proposing the rejoining point and the rejoining timing to the user.

A non-transitory storage medium according to the present disclosure

is a non-transitory storage medium storing a program for controlling a user terminal carried by a user,

wherein the user may be a user whose baggage is left in a safekeeping apparatus provided on a vehicle, and

the program may cause the user terminal to execute

transmitting position information of the user to an information processing apparatus that manages traveling of the vehicle; and

receiving a rejoining point and a rejoining timing at which the vehicle and the user are capable of rejoining together from the information processing apparatus, the rejoining point and the rejoining timing being derived on the basis of a scheduled traveling route of the vehicle and the position information of the user.

According to the present disclosure, it is possible to improve convenience when a user leaves baggage in a safekeeping apparatus provided on a vehicle.

### BRIEF DESCRIPTION OF THE DRAWINGS

FIG. 1 is a diagram illustrating a vehicle management system according to a first embodiment;

FIG. 2 is a view for explaining a vehicle which is managed by the vehicle management system;

FIG. 3 is a block diagram schematically illustrating examples of respective functional configurations of a management server and a user terminal;

FIG. 4 is a chart illustrating an example of a table configuration of user information according to the first embodiment;

FIG. 5 is a sequence chart illustrating a flow of an information process in the vehicle management system according to the first embodiment;

FIG. 6 is a chart illustrating an example of a table configuration of user information according to a second embodiment;

FIG. 7 is a sequence chart illustrating a flow of an information process in a vehicle management system according to the second embodiment; and

FIG. 8 is a chart illustrating an example of a table configuration of user information according to a third embodiment.

### DESCRIPTION OF THE EMBODIMENTS

A safekeeping apparatus according to the present disclosure is an apparatus for a user to leave baggage therein. The safekeeping apparatus is provided on a vehicle. For this reason, it is contemplated that, after baggage is left in the safekeeping apparatus by the user at a given place, the vehicle provided with the safekeeping apparatus moves from the place. In this case, if the user desires to pick up the baggage left in the safekeeping apparatus or if the user desires to additionally leave different baggage in the safekeeping apparatus, the user and the vehicle provided with the safekeeping apparatus need to rejoin together.

Under the above-described circumstances, in an information processing apparatus according to the present disclosure, a controller may derive a rejoining point and a rejoining timing at which the vehicle provided with the safekeeping apparatus storing the baggage of the user and the user are capable of rejoining together. At this time, the controller may derive the rejoining point and the rejoining timing on the basis of a scheduled traveling route of the vehicle and position information of the user.

For example, if the user is present relatively close to the scheduled traveling route of the vehicle, the user can move easily onto the scheduled traveling route of the vehicle. If the user is present at a given point on the scheduled traveling route of the vehicle when the vehicle arrives at the point, the vehicle and the user can rejoin together at the point. In the case where the user is present relatively close to the scheduled traveling route of the vehicle, it is easy for the vehicle to move from the scheduled traveling route to a point where the user is present. For this reason, the controller may derive a point on the scheduled traveling route of the vehicle or a point within a predetermined range from the scheduled traveling route of the vehicle as a rejoining point at which the vehicle and the user are capable of rejoining together. The controller may also derive a timing at which the vehicle arrives at the derived rejoining point as a rejoining timing at which the vehicle and the user are capable of rejoining together.

Additionally, the controller may propose the derived rejoining point and rejoining timing to the user. This allows the user to know the rejoining point and the rejoining timing, at which the user is capable of rejoining the vehicle provided with the safekeeping apparatus storing the baggage of the user. Thus, according to the present disclosure, the user can rejoin the vehicle at the rejoining point and the rejoining timing proposed by the information processing apparatus without personally setting, in advance, a rejoining point and a rejoining timing for the vehicle provided with the safekeeping apparatus and the user himself/herself. It is possible to improve convenience when the user leaves baggage in the safekeeping apparatus provided on the vehicle.

Specific embodiments of the present disclosure will be described below on the basis of the drawings. The technical scope of the present disclosure is not limited to dimensions, materials, shapes, relative arrangement, and the like of constituent components described in the present embodiments unless otherwise described.

### First Embodiment

(Overview of System)

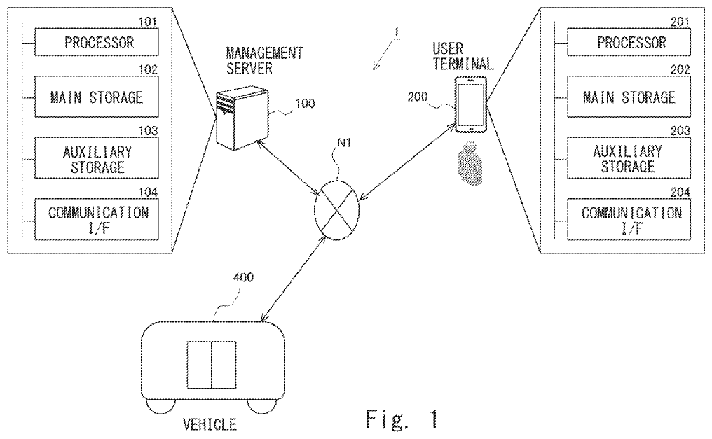

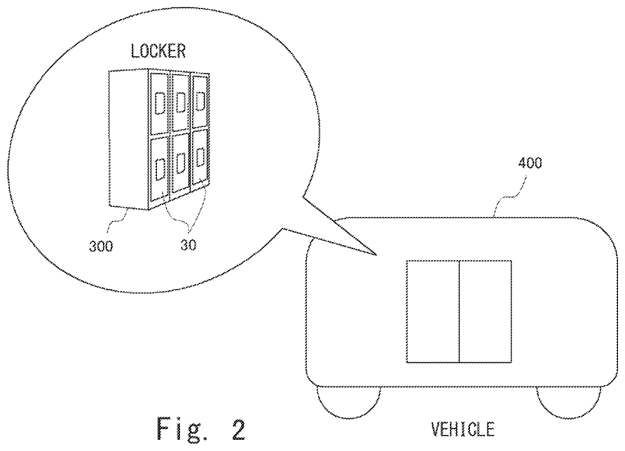

FIG. 1 is a diagram illustrating a schematic configuration of a vehicle management system according to the present embodiment. A vehicle management system 1 is a system which manages a vehicle provided with a locker. FIG. 2 is a view for explaining a vehicle which is managed by the vehicle management system 1.

The vehicle management system 1 is configured to include a management server 100, a user terminal 200, and a vehicle 400. In the vehicle management system 1, the management server 100, the user terminal 200, and the vehicle 400 are connected to one another by a network N1. As the network N1, for example, a WAN (Wide Area Network) which is a worldwide public telecommunication network, such as the Internet, or a telephone communication network for, e.g., cellular telephones may be adopted.

The vehicle 400 is provided with a locker 300 for a user to leave baggage (hereinafter referred to as “user baggage”) therein. The locker 300 includes a plurality of compartments 30 for storing user baggage. Each compartment 30 of the locker 300 is configured to be lockable and unlockable. Note that the locker 300 corresponds to a “safekeeping apparatus” according to the present disclosure in the present embodiment.

The vehicle 400 provided with the locker 300 is a vehicle capable of autonomous traveling. Note that the vehicle 400 need not be a driverless vehicle. For example, a maintenance worker or the like may be on the vehicle 400. The vehicle 400 need not be a vehicle capable of complete autonomous traveling. For example, the vehicle 400 may be a vehicle which a person drives or assists in driving, depending on the situation.

The vehicle 400 travels cyclically along a predetermined traveling route by autonomous traveling. Note that, if a user is to use the locker 300 provided on the vehicle 400, the vehicle 400 can travel autonomously to a point where the user desires to leave or take user baggage.

The management server 100 is a server apparatus which manages operations of a plurality of vehicles 400. The management server 100 manages the operations of the plurality of vehicles 400 that travel along different traveling routes. Note that only one vehicle 400 is illustrated in FIG. 1 for convenience sake.

The management server 100 is configured to include a computer having a processor 101, a main storage 102, an auxiliary storage 103, and a communication interface (communication I/F) 104. The processor 101 here is, for example, a CPU (Central Processing Unit) or a DSP (Digital Signal Processor). The main storage 102 is, for example, a RAM (Random Access Memory). The auxiliary storage 103 is, for example, a ROM (Read Only Memory), an HDD (Hard Disk Drive), or a flash memory. The auxiliary storage 103 may include a removable medium (removable recording medium). The removable medium here is, for example, a USB memory, an SD card, or a disk recording medium, such as a CD-ROM, a DVD, or a Blu-ray Disc. The communication I/F 104 is, for example, a LAN (Local Area Network) interface board or a wireless communication circuit for wireless communication.

An operating system (OS), various types of programs, various types of information tables, and the like are stored in the auxiliary storage 103. The processor 101 loads a program stored in the auxiliary storage 103 into the main storage 102 and executes the program, thereby implementing control as described later for causing a user whose baggage is left in the locker 300, and the vehicle 400 provided with the locker 300 to rejoin together. Note that some or all functions in the management server 100 may be implemented by a hardware circuit, such as an ASIC or an FPGA. Note that the management server 100 need not be implemented by a single physical configuration and may be composed of a plurality of computers which work in cooperation with each other. Note that the management server 100 corresponds to an “information processing apparatus” according to the present disclosure in the present embodiment.

The user terminal 200 is a terminal used by a user whose baggage is left in the locker 300. The user terminal 200 is configured to include a computer having a processor 201, a main storage 202, an auxiliary storage 203, and a communication interface (communication I/F) 204. Here, as specific examples of the processor 201, the main storage 202, and the auxiliary storage 203, the same ones as the above-described specific examples of the processor 101, the main storage 102, and the auxiliary storage 103 in the computer constituting the management server 100 can be named. The communication I/F 204 is, for example, an interface for communicating with different apparatuses including the management server 100 via the network N1 using a mobile communication service, such as 3G (3rd Generation) or LTE (Long Term Evolution). As an example of the user terminal 200, a smartphone, a tablet computer, a mobile computer, or a wearable computer can be named.

It is contemplated that, after user baggage is left in the locker 300 by a user at a given place, the vehicle 400 provided with the locker 300 moves from the place. For this reason, if the user desires to pick up the user baggage left in the locker 300, the user and the vehicle 400 need to rejoin together. The user may desire to additionally leave different baggage in the locker 300. In this case, the user and the vehicle 400 also need to rejoin together.

Under the circumstances, in the vehicle management system 1 according to the present embodiment, the management server 100 proposes a rejoining point and a rejoining timing at which the user and the vehicle 400 are capable of rejoining together to the user. This allows the user to join the vehicle 400 at the rejoining point and the rejoining timing proposed by the management server 100 without personally setting, in advance, a rejoining point and a rejoining timing for the vehicle 400 and the user himself/herself.

(Functional Configuration)

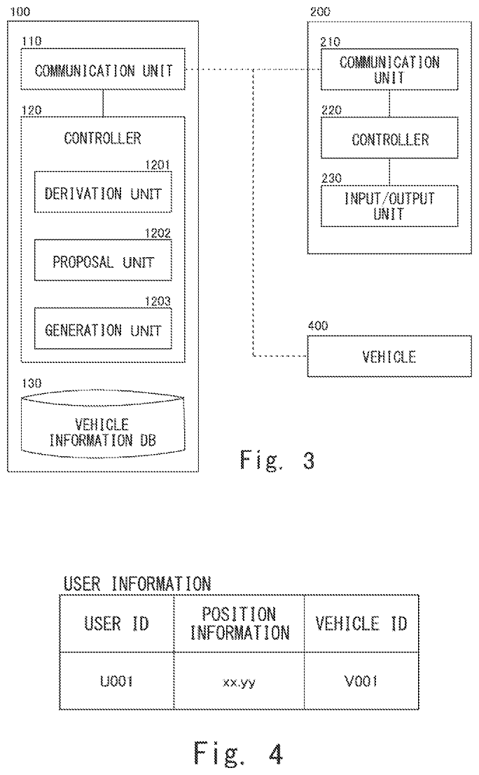

Respective functional configurations of the management server 100 and the user terminal 200 constituting the vehicle management system 1 will be described on the basis of FIG. 3. FIG. 3 is a block diagram schematically illustrating examples of the respective functional configurations of the management server 100 and the user terminal 200.

(Management Server)

The management server 100 has a communication unit 110, a controller 120, and a vehicle information database (vehicle information DB) 130. The communication unit 110 has a function of connecting the management server 100 to the network N1. The communication unit 110 can be implemented by the communication I/F 104. The controller 120 has a function of performing arithmetic processing for controlling the management server 100. The controller 120 can be implemented by the processor 101.

The controller 120 executes a process of receiving user information from the user terminal 200 using the communication unit 110. FIG. 4 is a chart illustrating an example of a table configuration of user information to be transmitted from the user terminal 200 to the management server 100, according to the present embodiment. As illustrated in FIG. 4, the user information has a user ID field, a position information field, and a vehicle ID field. A user ID which is identification information for identification of a user is entered into the user ID field. Position information indicating a current position of the user terminal 200, i.e., a current position of the user is entered into the position information field.

A vehicle ID which is identification information for identification of the vehicle 400 provided with the locker 300, in which the user has left user baggage, is entered into the vehicle ID field. Note that the user terminal 200 may receive the vehicle ID of the vehicle 400 provided with the locker 300 from the locker 300 or the vehicle 400 when the user leaves the user baggage in the locker 300. The user terminal 200 may enter the vehicle ID received from the locker 300 or the vehicle 400 into the vehicle ID field of the user information. User information is repeatedly transmitted from the user terminal 200 to the management server 100 at predetermined intervals after the user's leaving the user baggage in the locker 300. This allows the management server 100 to know the current position of the user on the basis of the position information included in user information.

An scheduled traveling route (i.e., a predetermined cyclic route) of each vehicle 400 provided with the locker 300 is stored in the vehicle information DB 130. Note that the vehicle information DB 130 is formed in the auxiliary storage 103.

The controller 120 includes, as functional units, a derivation unit 1201, a proposal unit 1202, and a generation unit 1203. The derivation unit 1201 has a function of deriving a rejoining point and a rejoining timing at which the vehicle 400 provided with the locker 300 storing user baggage and a user are capable of rejoining together. Specifically, the derivation unit 1201 acquires position information of the user which is included in user information received from the user terminal 200. The derivation unit 1201 also identifies the vehicle 400 provided with the locker 300 storing the user baggage on the basis of a vehicle ID included in the user information received from the user terminal 200. Additionally, the derivation unit 1201 extracts a scheduled traveling route of the identified vehicle 400 from the vehicle information DB 130. The derivation unit 1201 executes a process of deriving the rejoining point and the rejoining timing, at which the vehicle 400 and the user are capable of rejoining together on the basis of the position information of the user and the scheduled traveling route of the vehicle 400.

The proposal unit 1202 has a function of proposing a rejoining point and a rejoining timing at which the vehicle 400 and a user are capable of rejoining together to the user. Specifically, the proposal unit 1202 executes a process of transmitting a rejoining point and a rejoining timing which are derived by the derivation unit 1201 to the user terminal 200, using the communication unit 110.

The generation unit 1203 has a function of generating a traveling plan for the vehicle 400 for causing the vehicle 400 to rejoin a user at a rejoining point and a rejoining timing which the user desires. Specifically, a traveling plan for the vehicle 400 to arrive at the rejoining point that the user desires at the rejoining timing that the user desires or before the rejoining timing is generated. The controller 120 executes a process of transmitting the traveling plan generated by the generation unit 1203 to the vehicle 400 using the communication unit 110. When the vehicle 400 receives the traveling plan from the management server 100, the vehicle 400 travels autonomously in accordance with the received traveling plan.

(User Terminal)

The user terminal 200 has a communication unit 210, a controller 220, and an input/output unit 230. The communication unit 210 has a function of connecting the user terminal 200 to the network N1. The communication unit 210 can be implemented by the communication I/F 204. The controller 220 has a function of performing arithmetic processing for controlling the user terminal 200. The controller 220 can be implemented by the processor 201.

The input/output unit 230 has a function of accepting an input manipulation performed by a user and a function of proposing information to the user. For example, the input/output unit 230 may be configured to include a touch-panel display. In this case, the controller 220 activates a predetermined application, which allows the user to perform an input manipulation on the touch-panel display of the input/output unit 230.

(Flow of Information Process)

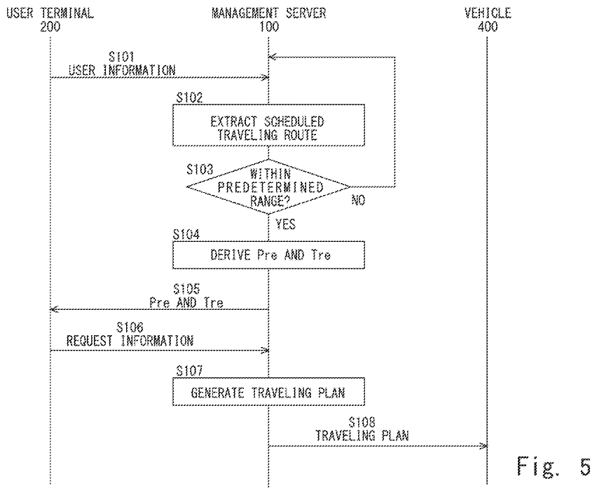

A flow of an information process in the vehicle management system 1 according to the present embodiment will be described on the basis of FIG. 5. FIG. 5 is a sequence chart illustrating the flow of the information process in the vehicle management system 1 according to the present embodiment. A flow of the information process at the time of causing a user and the vehicle 400 to rejoin together in the vehicle management system 1 is illustrated in FIG. 5.

In the vehicle management system 1 according to the present embodiment, user information is repeatedly transmitted from the user terminal 200 to the management server 100 at predetermined intervals (S101). When the management server 100 receives user information from the user terminal 200, the management server 100 extracts a scheduled traveling route of the vehicle 400 corresponding to a vehicle ID included in the user information from the vehicle information DB 130 (S102). The management server 100 then judges, on the basis of position information of a user included in the user information and the scheduled traveling route of the vehicle 400, whether the user is present within a predetermined range from the scheduled traveling route of the vehicle 400 (S103).

If the user is present relatively close to the scheduled traveling route of the vehicle 400, the user can move easily onto the scheduled traveling route of the vehicle 400. If the user is present at a given point on the scheduled traveling route of the vehicle 400 when the vehicle 400 arrives at the point, the vehicle 400 and the user can rejoin together at the point. In the case where the user is present relatively close to the scheduled traveling route of the vehicle 400, it is also easy for the vehicle 400 to move from the scheduled traveling route to a point where the user is present. For this reason, the predetermined range is set as a range from within which the user moves easily to the scheduled traveling route of the vehicle 400 or a range to within which the vehicle 400 moves easily from the scheduled traveling route of the vehicle 400.

If it is judged that the user is not present within the predetermined range from the scheduled traveling route of the vehicle 400 (NO in S103), the management server 100 waits until reception of next user information. On the other hand, if the user is present within the predetermined range from the scheduled traveling route of the vehicle 400 (YES in S103), the management server 100 derives a rejoining point Pre and a rejoining timing Tre at which the vehicle 400 and the user are capable of rejoining together (S104).

At this time, the management server 100 derives a point on the scheduled traveling route of the vehicle 400 or a point within the predetermined range from the scheduled traveling route of the vehicle 400 as the rejoining point Pre, at which the vehicle 400 and the user are capable of rejoining together. For example, the management server 100 may derive a point closest to a current position of the user on the scheduled traveling route of the vehicle 400 as the rejoining point Pre. Alternatively, the management server 100 may derive the current position of the user as the rejoining point Pre. Alternatively, the management server 100 may derive a point present between the scheduled traveling route of the vehicle 400 and the current position of the user (e.g., a middle point between the two points) as the rejoining point Pre. Additionally, the management server 100 may derive a timing at which the vehicle 400 is expected to arrive at the derived rejoining point as the rejoining timing Tre, at which the vehicle 400 and the user are capable of rejoining together. Note that the processes in S102 to S104 are executed by the derivation unit 1201 in the controller 120 of the management server 100.

The management server 100 transmits the derived rejoining point Pre and rejoining timing Tre to the user terminal 200 (S105). With this transmission, the rejoining point Pre and the rejoining timing Tre are proposed to the user by the input/output unit 230 in the user terminal 200. Note that the process in S105 is executed by the proposal unit 1202 in the controller 120 of the management server 100.

If the user desires to rejoin the vehicle 400 at the rejoining point Pre and the rejoining timing Tre that are proposed in the user terminal 200, request information is transmitted from the user terminal 200 to the management server 100 (S106). The request information at this time is information for requesting rejoining with the vehicle 400 at the rejoining point Pre and the rejoining timing Tre.

When the management server 100 receives the request information from the user terminal 200, the management server 100 generates a traveling plan of the vehicle 400 for causing the vehicle 400 to rejoin the user at the rejoining point Pre and the rejoining timing Tre (S107). The traveling plan is a plan for causing the vehicle 400 to arrive at the rejoining point Pre at the rejoining timing Tre or before the rejoining timing Tre. Note that the process in S107 is executed by the generation unit 1203 in the controller 120 of the management server 100.

The management server 100 transmits the generated traveling plan to the vehicle 400 (S108). Upon receipt of the traveling plan from the management server 100, the vehicle 400 runs autonomously on the basis of the traveling plan. For this reason, if the user is present at the rejoining point Pre at the rejoining timing Tre, the user and the vehicle 400 can rejoin together. Thus, the vehicle management system 1 according to the present embodiment allows the user to rejoin the vehicle 400 at the rejoining point Pre and the rejoining timing Tre without personally setting, in advance, a rejoining point and a rejoining timing for the vehicle 400 and the user himself/herself. It is possible to improve convenience when a user leaves baggage in the locker 300 provided on the vehicle 400.

(Modification)

Note that a user may not desire to join the vehicle 400 at a rejoining point Pre and a rejoining timing Tre which are proposed by the management server 100. In this case, after the rejoining point Pre and the rejoining timing Tre are proposed to the user by the input/output unit 230 of the user terminal 200, the user himself/herself enters a rejoining point and a rejoining timing at which the user desires to rejoin the vehicle 400 into the user terminal 200.

With the entry, request information for requesting rejoining with the vehicle 400 at the rejoining point and the rejoining timing designated by the user is transmitted from the user terminal 200 to the management server 100. Upon receipt of the request information from the user terminal 200, the management server 100 generates a traveling plan of the vehicle 400 for causing the vehicle 400 to rejoin the user at the rejoining point and the rejoining timing designated by the user. The management server 100 further transmits the generated traveling plan to the vehicle 400. This allows the user to join the vehicle 400 at the rejoining point and the rejoining timing designated by the user himself/herself.

### Second Embodiment

In the present embodiment as well, a vehicle management system 1 is configured to include a management server 100, a user terminal 200, and a vehicle 400. In the present embodiment, user information is repeatedly transmitted from the user terminal 200 to the management server 100. Note that the present embodiment is different from the above-described first embodiment in that biological information of a user is included in user information to be transmitted from the user terminal 200.

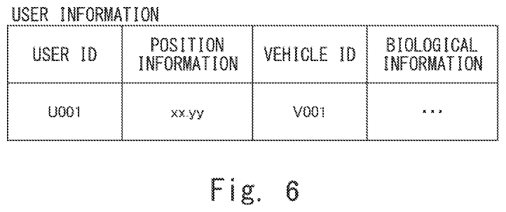

FIG. 6 is a chart illustrating an example of a table configuration of user information to be transmitted from the user terminal 200 to the management server 100, according to the present embodiment. As illustrated in FIG. 6, the user information has a biological information field in addition to a user ID field, a position information field, and a vehicle ID field. Biological information indicating a physical state of the user is entered into the biological information field. As examples of the biological information, a body temperature, a pulse, a heart rate, a blood pressure, a sweat rate, and the like can be named.

Note that, if the user terminal 200 is a wearable computer, the user terminal 200 itself may have a function of acquiring biological information from a body of a user. If the user terminal 200 is a terminal other than a wearable computer, the user terminal 200 may have a function of receiving biological information from a wearable computer which is worn by the user.

As a user in the present embodiment, a runner which does running on a public road can be conceived. In this case, the user leaves his/her change of clothes or the like as user baggage in a locker 300 before the start of running. At this time, the user leaves the user baggage in the locker 300 provided on the vehicle 400 that is to travel near his/her running course. The user rejoins the vehicle 400 after the end of the running and picks up the user baggage from the locker 300.

In the above-described case, the user sets, as a predetermined condition, a physical state of himself/herself serving as a guide for indicating that an ending time of running is approaching. The predetermined condition here may be set to be that a value of biological information, such as a body temperature, a pulse, a heart rate, a blood pressure, or a sweat rate, reach a predetermined threshold. The user registers, in advance, the predetermined condition in the management server 100 via the user terminal 200. Note that the predetermined condition need not be set by the user himself/herself. A physical state of a common runner serving as a guide for indicating that an ending time of running is approaching may be set as the predetermined condition.

The management server 100 can know a physical state of a user during running on the basis of biological information included in user information which is received from the user terminal 200. For this reason, if a physical state of a user meets the predetermined condition during running of the user, the management server 100 derives a rejoining point Pre and a rejoining timing Tre and transmits the rejoining point Pre and the rejoining timing Tre to the user terminal 200.

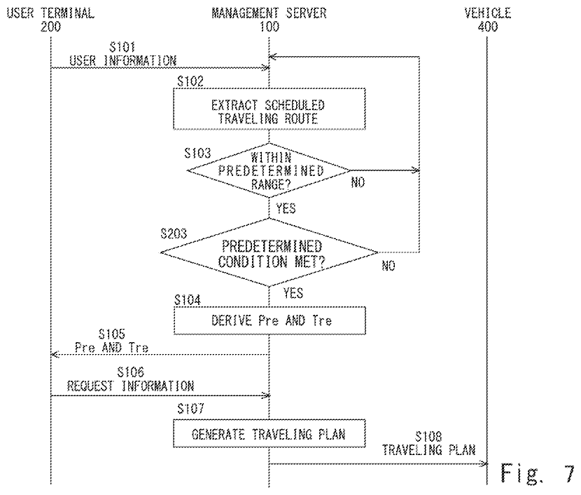

FIG. 7 is a sequence chart illustrating a flow of an information process in the vehicle management system 1 according to the present embodiment. Differences of the sequence chart illustrated in FIG. 7 from the sequence chart illustrated in FIG. 5 will be described below. In the present embodiment, the information process illustrated in FIG. 7 is executed during running of a user.

In the present embodiment, biological information of the user is included in user information which the management server 100 receives from the user terminal 200 in S101, as described above. If the management server 100 judges in S103 that the user is present within a predetermined range from a scheduled traveling route of the vehicle 400, the management server 100 judges, on the basis of the biological information included in the user information, whether a physical state of the user meets a predetermined condition (S203).

If the physical state of the user does not meet the predetermined condition (NO in S203), the user can be expected to continue the running for a while. For this reason, in this case, the management server 100 waits until reception of next user information. On the other hand, if the physical state of the user meets the predetermined condition (YES in S203), the management server 100 derives a rejoining point Pre and a rejoining timing Tre (S104). The management server 100 transmits the derived rejoining point Pre and rejoining timing Tre to the user terminal 200 (S105).

For the above-described reason, even in a case where a running goal is not determined in advance, when the physical state of the user himself/herself meets the predetermined condition, the user can accept proposal of the rejoining point Pre and the rejoining timing Tre for rejoining with the vehicle 400. The user can rejoin the vehicle 400 by doing running so as to arrive at the rejoining point Pre before the rejoining timing Tre.

The above-described modification of the first embodiment can also be applied to the present embodiment. In this case, if the user does not desire to end the running at the rejoining point Pre and the rejoining timing Tre proposed by the management server 100, the user can designate a rejoining point and a rejoining timing different from the rejoining point Pre and the rejoining timing Tre.

### Third Embodiment

In the present embodiment as well, a vehicle management system 1 is configured to include a management server 100, a user terminal 200, and a vehicle 400. In the present embodiment, user information is repeatedly transmitted from the user terminal 200 to the management server 100 at predetermined intervals. Note that the present embodiment is different from the above-described first embodiment in that purchase information which is information on purchase of an article by a user after the user's leaving user baggage in a locker 300 is included in user information to be transmitted from the user terminal 200.

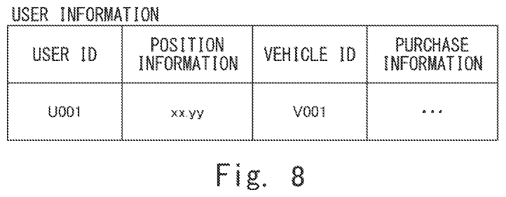

FIG. 8 is a chart illustrating an example of a table configuration of user information to be transmitted from the user terminal 200 to the management server 100. As illustrated in FIG. 8, the user information has a purchase information field in addition to a user ID field, a position information field, and a vehicle ID field. Purchase information is entered into the purchase information field. As an example of the purchase information, the type of an article purchased by a user or the like can be named.

Note that the user terminal 200 may acquire purchase information when a user performs payment processing at the time of purchase of an article using the user terminal 200. If the user makes a plurality of article purchases, the user terminal 200 additionally enters purchase information into the purchase information field of the user information each time the user makes an article purchase.

If the user purchases an article after the user leaves user baggage in the locker 300, baggage carried by the user increases. For this reason, the user may desire to additionally leave the purchased article in the locker 300. At this time, the user sets a condition serving as a guide for the user himself/herself to desire to additionally leave baggage in the locker 300 as a predetermined condition. The predetermined condition here may be set as the quantity or the types of articles purchased by the user. The user registers in advance the predetermined condition in the management server 100 via the user terminal 200.

The management server 100 can know an article purchased by the user on the basis of purchase information included in user information received from the user terminal 200. For this reason, if the user purchases articles which meet the predetermined condition after leaving user baggage in the locker 300, the management server 100 derives a rejoining point Pre and a rejoining timing Tre and transmits the rejoining point Pre and the rejoining timing Tre to the user terminal 200. Note that a flow of an information process in the vehicle management system 1 according to the present embodiment is the same as the flow of the information process illustrated in the sequence chart illustrated in FIG. 7.

For the above-described reason, even in a case where a point at which baggage is to be additionally left in the locker 300 is not determined in advance, when the user purchases articles which meet the predetermined condition, the user can accept proposal of the rejoining point Pre and the rejoining timing Tre for rejoining with the vehicle 400.

The above-described modification of the first embodiment can also be applied to the present embodiment. In this case, if the user does not desire to additionally leave baggage in the locker 300 at the rejoining point Pre and the rejoining timing Tre proposed by the management server 100, the user can designate a rejoining point and a rejoining timing different from the rejoining point Pre and the rejoining timing Tre.

### Other Embodiments

The embodiments described above are merely examples, and the present disclosure may be changed and implemented as appropriate within the scope of the disclosure. Furthermore, processes and structure described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMs, EEPROMs, magnetic cards, flash memories, or optical cards.

What is claimed is:

1. An information processing apparatus comprising
a controller configured to execute:
deriving, on a basis of a scheduled traveling route of a vehicle provided with a safekeeping apparatus storing baggage of a user and position information of the user, a rejoining point and a rejoining timing at which the vehicle and the user are capable of rejoining together; and
proposing the rejoining point and the rejoining timing to the user.

2. The information processing apparatus according to claim 1, wherein
the controller
derives the rejoining point and the rejoining timing if the user is present within a predetermined range from the scheduled traveling route of the vehicle.

3. The information processing apparatus according to claim 1, wherein
the controller
further executes acquiring state information on a state of the user after the user leaves the baggage in the safekeeping apparatus, and
proposes the rejoining point and the rejoining timing to the user if the state of the user indicated by the state information meets a predetermined condition.

4. The information processing apparatus according to claim 3, wherein
the state information is biological information indicating a physical state of the user.

5. The information processing apparatus according to claim 3, wherein
the state information is information on purchase of an article by the user.

6. The information processing apparatus according to claim 3, wherein
the predetermined condition is a condition which is set in advance by the user.

7. The information processing apparatus according to claim 1, wherein
the controller
further executes generating a traveling plan of the vehicle for causing the vehicle to rejoin the user at the proposed rejoining point and rejoining timing if the controller receives request for rejoining at the proposed rejoining point and rejoining timing from the user after proposing the rejoining point and the rejoining timing to the user.

8. The information processing apparatus according to claim 1, wherein
the controller
further executes, if the controller receives request for rejoining at a point or a timing different from the proposed rejoining point and rejoining timing from the user after proposing the rejoining point and the rejoining timing to the user, generating a traveling plan of the vehicle for causing the vehicle to rejoin the user at the rejoining point and the rejoining timing designated by the user.

9. The information processing apparatus according to claim 1, wherein
the controller
receives position information of the user from a user terminal carried by the user, and
transmits the rejoining point and the rejoining timing to the user terminal.

10. The information processing apparatus according to claim 1, wherein
the vehicle is a vehicle capable of autonomous traveling.

11. An information processing method comprising:
deriving, on a basis of a scheduled traveling route of a vehicle provided with a safekeeping apparatus storing baggage of a user and position information of the user, a rejoining point and a rejoining timing at which the vehicle and the user are capable of rejoining together; and
proposing the rejoining point and the rejoining timing to the user.

12. The information processing method according to claim 11, wherein
the rejoining point and the rejoining timing are derived if the user is present within a predetermined range from the scheduled traveling route of the vehicle.

13. The information processing method according to claim 11, further comprising
acquiring state information on a state of the user after the user leaves the baggage in the safekeeping apparatus, wherein
the rejoining point and the rejoining timing are proposed to the user if the state of the user indicated by the state information meets a predetermined condition.

14. The information processing method according to claim 13, wherein
the state information is biological information indicating a physical state of the user.

15. The information processing method according to claim 13, wherein
the state information is information on purchase of an article by the user.

16. The information processing method according to claim 13, wherein
the predetermined condition is a condition which is set in advance by the user.

17. The information processing method according to claim 11, further comprising
generating a traveling plan of the vehicle for causing the vehicle to rejoin the user at the proposed rejoining point and rejoining timing if request for rejoining at the proposed rejoining point and rejoining timing is received from the user after the rejoining point and the rejoining timing are proposed to the user.

18. A non-transitory storage medium storing a program for controlling a user terminal carried by a user,
wherein the user is a user whose baggage is left in a safekeeping apparatus provided on a vehicle, and
the program causes the user terminal to execute:
transmitting position information of the user to an information processing apparatus that manages traveling of the vehicle; and
receiving a rejoining point and a rejoining timing at which the vehicle and the user are capable of rejoining together from the information processing apparatus, the rejoining point and the rejoining timing being derived on a basis of a scheduled traveling route of the vehicle and the position information of the user.

19. The non-transitory storage medium according to claim 18, wherein
the rejoining point and the rejoining timing are derived in the information processing apparatus if the user is present within a predetermined range from the scheduled traveling route of the vehicle.

20. The non-transitory storage medium according to claim 18, wherein
the program
causes the user terminal to further execute transmitting state information on a state of the user after the user leaves the baggage in the safekeeping apparatus to the information processing apparatus, and
the rejoining point and the rejoining timing are transmitted from the information processing apparatus to the user terminal if the state of the user indicated by the state information meets a predetermined condition.
